(19) United States
(12) Patent Application Publication
(10) Pub. No.: US 2022/0019522 A1
(43) Pub. Date: Jan. 20, 2022

(54) AUTOMATED SEQUENCING OF SOFTWARE TESTS USING DEPENDENCY INFORMATION

(71) Applicant: Red Hat, Inc., Raleigh, NC (US)

(72) Inventors: Miroslav Jaros, Brno (CZ); Stefan Bunciak, Brno (CZ)

(21) Appl. No.: 16/932,943

(22) Filed: Jul. 20, 2020

(51) Int. Cl. G06F 11/36; G06F 8/41

(52) U.S. Cl. CPC G06F 11/3688; G06F 11/3664; G06F 11/3684; G06F 8/433

(57) ABSTRACT

Dependency information can be used for automatic sequencing of software tests. For example, a computing device can receive dependency information indicating dependency relationships among software tests usable to test a target software item. The computing device can determine assignments of the software tests to different testing phases in a sequence of testing phases based on the dependency information. This may involve the computing device assigning each software test to a particular testing phase based on whether the software test is a dependency of or is a dependent on another software test, such that each testing phase in the sequence of testing phases is assigned a unique subset of software tests. The computing device can then generate an output indicating the assignments of the software tests to the different testing phases in the sequence of testing phases.

### TECHNICAL FIELD

The present disclosure relates generally to software testing. More specifically, but not by way of limitation, this disclosure relates to using dependency information about software tests to automatically determine a software-test sequence.

### BACKGROUND

Quality engineers are often tasked with testing software applications created by software developers to ensure that the software applications are bug-free and comply with certain standards. There are different types of software testing including unit tests, integration tests, and acceptance tests. Unit tests validate individual components of a software application. For example, a single loop of code in a software application, which serves as a unit of the whole code of the software application, can be tested using unit testing. Integration testing combines individual units to test their function as a group. Integration tests can validate that the units of the code for the software application function correctly when run in conjunction with each other. Acceptance testing is used to evaluate a system's compliance with requirements to assess whether the software application is acceptable for delivery to user devices.

### BRIEF DESCRIPTION OF THE DRAWINGS

FIG. 1 is a block diagram of an example of a system for implementing automatic sequencing of software tests using dependency information according to some aspects of the present disclosure.

FIG. 2A is a diagram of an example of dependency relationships between software tests according to some aspects of the present disclosure.

FIG. 2B is a diagram of an example of a sequence of testing phases in which the software tests of FIG. 2A are to be applied to a software application according to some aspects of the present disclosure.

FIG. 3 is a block diagram of an example of a system for implementing automatic sequencing of software tests using dependency information according to some aspects of the present disclosure.

FIG. 4 is a flow chart of an example of a process for automatically sequencing software tests using dependency information according to some aspects of the present disclosure.

### DETAILED DESCRIPTION

Software tests are typically applied randomly to a target software item, such as a software application, which makes it hard to replicate a sequence of tests applied to the target software item. Additionally, software tests are typically applied in an isolated way in which test results from previous tests are isolated from and not considered by subsequent tests. Since the software tests do not influence one another, the test results may be unrealistic or inaccurate. Further, it is common for multiple software tests to rely on the same computing resources, such as databases and services. In a typical testing scenario, the testing system will deploy the computing resources required for each test individually at the start of the software test and then shutdown the computing resources at the end of the software test. This may result in the same computing resources being deployed and shutdown multiple times, sometimes sequentially, which is an inefficient use of time and computing resources.

Some examples of the present disclosure can overcome one or more of the abovementioned problems by determining a particular order in which to apply software tests to a target software item, based on dependency information about the software tests. Additionally, some examples can bridge the gap between software tests so that computing resources and test results are shared among the software tests, to improve accuracy and efficiency.

As one particular example, a quality or test engineer can input dependency information indicating dependency relationships among software tests to a computing system. A particular software test can be dependent upon another software test if the particular software test relies on outputs or computing resources from the other software test. Based on the dependency information, the computing system can then automatically assign the software tests to various testing phases in a sequence of testing phases, so that each testing phase has a unique subset of software tests. After assigning the software tests to the sequence of testing phase, the computing system can receive an input indicating the target software item that is to be tested. The computing system can perform each testing phase in sequence by executing all of the software tests assigned to the respective testing phase before transitioning to the next testing phase. The computing system can execute the unique subset of software tests for a particular testing phase in parallel to one another if the computing system determines none of the software tests conflict. If two or more software tests are determined to conflict, the computing system can execute the two or more software tests in sequence during the particular testing phase.

Each software test can generate test outputs that can be stored in a data structure, such as a shared context, that is shared among some or all of the testing phases. The shared data structure can allow a current testing phase to access the test outputs from the software tests executed in one or more prior testing phases, so that the current testing phase can use the test outputs as inputs for its software tests. This can bridge the gap between testing phases to enable the outputs of prior testing phases to influence subsequent testing phases.

After the computing system executes the sequence of testing phases, the computing system can generate an output indicating which software tests passed, failed, and were skipped during the sequence of testing phases. The output can allow a user to make adjustments to the software application, for example to correct any bugs or other problems identified by the sequence of tests, before the software application is deployed to other user devices.

These illustrative examples are given to introduce the reader to the general subject matter discussed here and are not intended to limit the scope of the disclosed concepts. The following sections describe various additional features and examples with reference to the drawings in which like numerals indicate like elements but, like the illustrative examples, should not be used to limit the present disclosure.

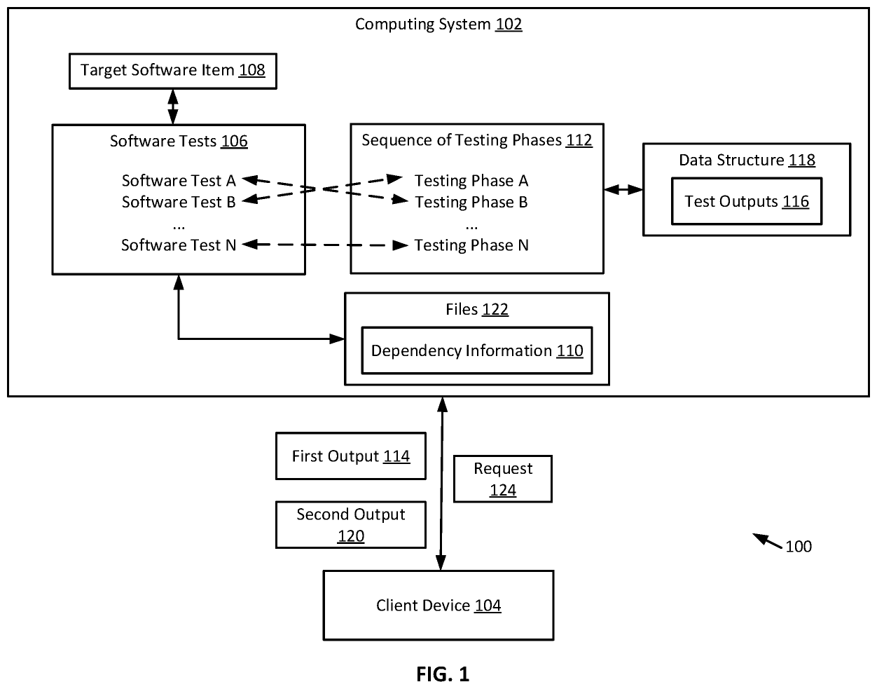

FIG. 1 is a block diagram of an example of a system 100 for automatically sequencing software tests using dependency information according to some aspects of the present disclosure. The system 100 can include a computing system 102 that can communicate with any number of client devices, such as client device 104. Examples of the client device 104 can include a desktop computer or a mobile device (e.g., a smartphone, laptop, or tablet).

The computing system 102 can include software tests 106 for testing a target software item 108 for bugs or other problems. In some examples, the software tests 106 may not include unit tests, since unit tests are individual tests executed in isolation without any dependencies. But the software tests 106 may include other types of tests that are higher level than unit tests, such as integration and acceptance tests.

The computing system 102 can also include dependency information 110 indicating dependency relationships among the software tests 106. For example, a first software test among the software tests 106 may verify that a file can be uploaded to a webserver and a second software test among the software tests 106 may verify that an uploaded file can be viewed by a user accessing the webserver. In this scenario, the second software test has a dependency on the first software test since viewing an uploaded file depends on the file being successfully uploaded. The dependency information 110 can be provided as input by a user to the computing system 102, or the computing system 102 can automatically determine the dependency information 110 (e.g., by analyzing characteristics and features of the software tests 106). Regardless of how the computing system 102 obtains the dependency information 110, the computing system 102 can store the dependency information 110 in files 122 associated with the software tests 106.

The computing system 102 can use the dependency information 110 to assign the software tests 106 to different testing phases in a sequence of testing phases 112. For example, the dependency information 110 can initially be arranged as a disconnected data structure that can be referred to as a forest. The computing system 102 can transform the forest into a tree-like structure by connecting parts of the dependency information 110. If a particular software test does not depend on another software test, then that particular software test can be assigned a dependency on a common base node in order to create the tree-like structure. Each software test (e.g., Software Test A, Software Test B, . . . , Software Test N) in the software tests 106 can be assigned to a particular testing phase (e.g., Testing Phase A, Testing Phase B, . . . , Testing Phase N) in the sequence of testing phases 112 based on the tree-like structure. For example, each software test can be assigned to a particular testing phase based on whether the software test is a dependency of or dependent on another software test in the tree-like structure. In this way, the computing system 102 can assign a unique subset of software tests from among the software tests 106 to each testing phase among the sequence of testing phases 112. Although referred to as a “subset” herein, it will be appreciated that the unique subset of software tests can include one or more software tests. For example, the dependency information 110 can indicate Software Test B depends on Software Test A. The computing system 102 can assign Software Test B to Testing Phase B and Software Test A to Testing Phase A, where Software Test B is the unique set of software tests for Testing Phase B and Software Test A is the unique subset of software tests for Testing Phase A. After determining the assignments of the software tests 106 to the different testing phases, the computing system 102 can generate a first output 114 indicating the assignments of the software tests 106 to the different testing phases in the sequence of testing phases 112. The computing system 102 may transmit the first output 114 to the client device 104.

In some examples, the client device 104 can transmit a request 124 for a target software item 108 to be tested by the computing system 102. The computing system 102 can receive the request 124 and responsively test for errors relating to the target software item 108 by performing each respective testing phase in the sequence of testing phases 112 on the target software item 108. Errors can include a software test failing or being skipped during the particular testing phase that the software test is assigned to.

Performing each respective testing phase can involve the computing system 102 executing the unique subset of software tests for the respective testing phase, without executing other software tests among the software tests 106. For a particular testing phase, the computing system 102 can determine if two or more software tests assigned to the particular testing phase conflict with one another. For example, two or more software tests can conflict if the computing system 102 does not have sufficient computing resources to support running the two or more software tests in parallel. As another example, two or more software tests can conflict if they require the same resources to properly execute. As yet another example, two or more software tests can conflict if their combined resource-consumption would exceed a maximum allowable limit. If the computing system 102 determines that two or more software tests conflict, the computing system 102 can execute the two or more software tests in sequence to one another during the particular testing phase. If the computing system 102 determines that two or more software tests do not conflict with one another, the computing system 102 can execute the two or more software tests in parallel to one another during the particular testing phase. Executing software tests in parallel can speed up the execution of the particular testing phase. Once the computing system 102 executes the unique subset of software tests for the respective testing phase, the computing system 102 can transition to the next testing phase.

For each testing phase, the computing system 102 can generate a respective set of test outputs as a result of executing the unique subset of software tests assigned to the respective testing phase on the target software item 108. The respective set of test outputs can indicate the results of executing the unique subset of software tests on the target software item 108. The computing system 102 can store the respective set of test outputs in a data structure 118, which may be stored in a volatile memory device or a non-volatile memory device. The data structure 118 can be shared among some or all of the testing phases in the sequence of testing phases 112, such that the data structure 118 can store test outputs 116 for some or all of the testing phases in the sequence of testing phases 112. In this way, a testing phase can access the test outputs 116 stored in the data structure 118 from one or more previous testing phases and use the test outputs 112 as inputs for the software tests in the testing phase.

As a more specific example, a software test in a testing phase can test whether the target software item 108 can successfully upload a file to a server. The computing system 102 can execute the software test and store a test output 116 (e.g., pass or fail) in the data structure 118. A subsequent testing phase can include a software test for testing if a file uploaded to the server can be accessed. The subsequent testing phase can access the test outputs 116 and determine if and how to execute its software test for testing file access. For example, if the file-upload test passed in the previous testing phase, the file-access test can be executed. And if the file-upload test failed in the previous testing phase, the file-access test can be ignored or flagged, since realistically a file that does not exist on the server cannot be accessed.

After the computing system 102 executes the final testing phase in the sequence of testing phases 112, the computing system 102 can transmit a second output 120 to the client device 104 indicating which software tests 106 passed, failed, and were skipped during the sequence of testing phases 112. The second output 120 can indicate to a user which components of the target software item 108 should be adjusted (e.g., fixed) based on which software tests 106 passed, failed, and were skipped.

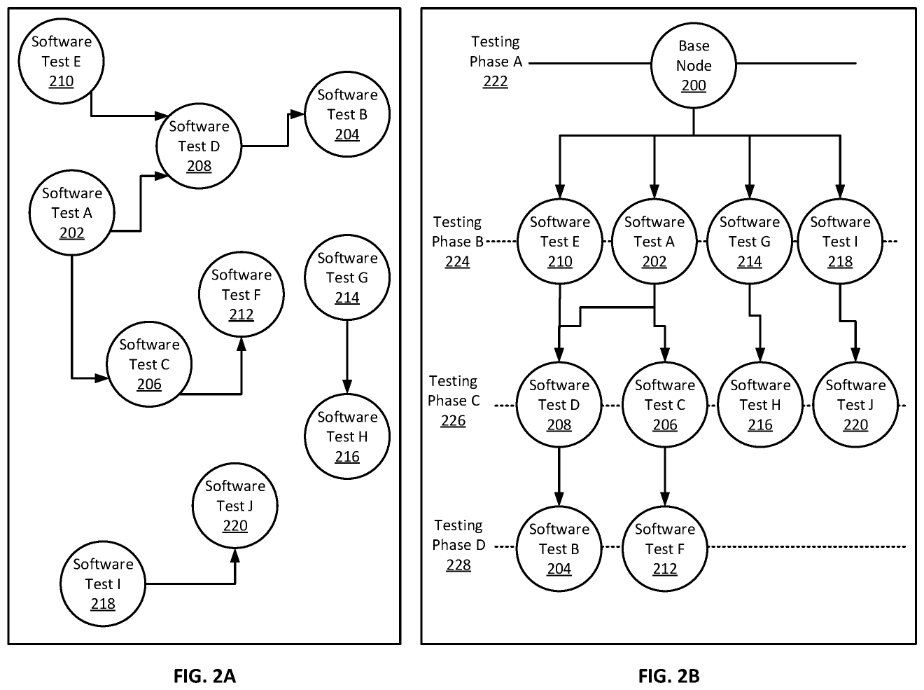

FIG. 2A is a diagram of an example of dependency relationships between software tests according to some aspects of the present disclosure. At least some of the dependency relationships may be disconnected from one another and conceptualized as a disconnected data structure or “forest” of software tests.

The forest can include any number of software tests and disconnected structures. For example, FIG. 2A includes three disconnected structures with Software Tests A-J and arrows indicating dependencies. The first disconnected structure includes Software Test B 204, which is dependent on Software Test D 208, Software Test E 210, and Software Test A 202. Software Test D 208 is dependent on Software Test A 202 and Software Test E 210. Software Test A 202 also has a dependent Software Test C 206, which in turn has a dependent Software Test F 212. So, Software Test F 212 can rely on one or both of the test outputs of Software Test C 206 and Software Test A 202. Software Test A 202 and Software Test E 210 are not dependent on any other software tests.

The second disconnected structure includes Software Test H 216 that is dependent on Software Test G 214. The third disconnected structure includes Software Test J 220 that is dependent on Software Test I 218. Software Test H 216 and Software Test J 220 rely on the test outputs of Software Test G 214 and Software Test I 218, respectively. Software Test G 214 and Software Test I 218 do not depend on any other software tests.

FIG. 2B shows a tree-like structure generated by a computing system that indicates a sequence of testing phases for Software Tests A-J in FIG. 2A. The tree-like structure combines the disconnected data structures representing the dependency relationships into a connected structure. Of course, there can be a different number of software tests and testing phases than what is shown in FIGS. 2A-B; those figures are intended to be non-limiting and are shown for illustrative purposes.

The computing system can assign software tests that do not have a dependency on any other software test a dependency on a new, void dependency set. For example, the computing system can assign Software Test A 202, Software Test E 210, Software Test G 214, and Software Test I 218 a dependency on Base Node 200 since they do not depend on any other software tests. Base Node 200 can allow the three disconnected structures to be combined into one, tree-like structure. The computing system can sort the software tests into a sequence of testing phases, with each testing phase having a unique subset of software tests. The computing system can determine the unique subset of software tests for each testing phase based on distance from Base Node 200. For example, Testing Phase A 222 can be an initial testing phase including Base Node 200. Software Test A 202, Software Test E 210, Software Test G 214, and Software Test I 218 can be assigned to Testing Phase B 224 because they are only dependent on Base Node 200, and therefore are a distance of one from Testing Phase A 222.

Software Test D 208, Software Test C 206, Software Test H 216, and Software Test J 220 only depend on software tests included in Testing Phase B 224, so they can be considered a distance of two from Testing Phase A 222. As a result, the computing system can assign Software Test D 208, Software Test C 206, Software Test H 216, and Software Test J 220 to Testing Phase C 226, which is subsequent to Testing Phase B 224. In some examples, the computing system can use the test outputs from the software tests in Testing Phase B 224 as inputs for the software tests in Testing Phase C 226 that depend on the respective software test in Test Phase B 224. For example, the computing system can use test outputs of Software Test A 202 in Testing Phase B 224 as inputs for Software Test D 208 and Software Test C 206 in Testing Phase C226.

Software Test B 204 and Software Test F 212 depend respectively on Software Test D 208 and Software Test C 206 of Testing Phase C 226. The computing system can assign Software Test B 204 and Software Test F 212 to Testing Phase D 228 that is subsequent to Testing Phase C 226. The computing system can use test outputs from one or more of the software tests from Testing Phases A-C as test inputs for one of the software tests in Testing Phase D. For example, the computing system can use test outputs from Software Test A 202 and Software Test C 206 as an input for Software Test F 212 in Testing Phase D 228.

The computing system can execute all the software tests of a testing phase before transitioning to the next testing phase. For example, the computing system can execute Software Test E 210, Software Test A 202, Software Test G 214, and Software Test I 218 in Testing Phase B 224 before executing any remaining software tests in Testing Phase C 226 and Testing Phase D 228.

In some examples, the computing system can determine two or more software tests in a testing phase conflict with one another, and can execute those two or more software tests in sequence during the testing phase. For example, the computing system can determine Software Test E 210 and Software Test A 202 conflict during Testing Phase B 224 because, if executed in parallel, they require an excessive amount of computing resources that the computing system cannot support. In response to determining Software Test E 210 and Software Test A 202 conflict, the computing system can execute Software Test E 210 and Software Test A 202 in sequence during Testing Phase B 224. In an alternative example, the computing system can determine that two or more software tests do not conflict in a testing phase. In response to determining two or more software tests do not conflict, the computing system can execute the software tests for a testing phase in parallel.

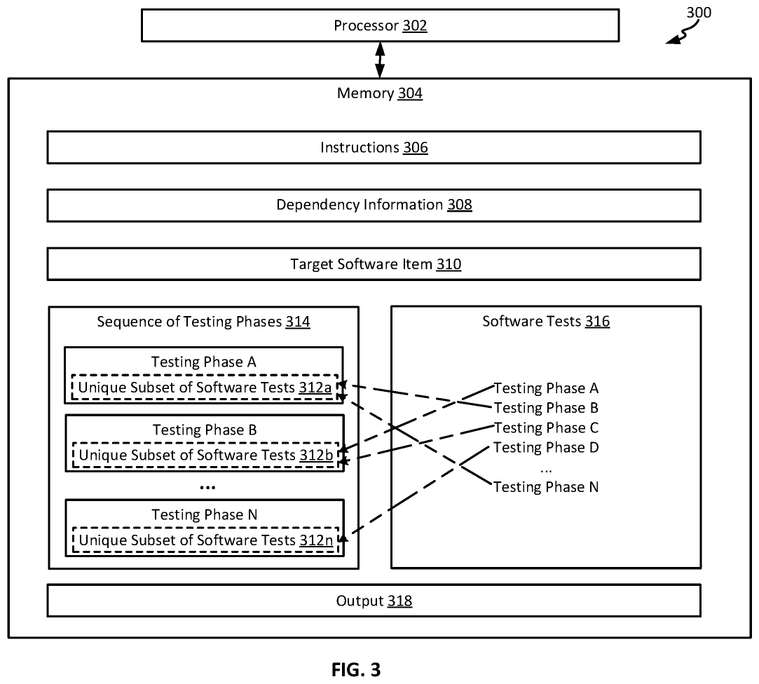

FIG. 3 is a block diagram of an example of a system 300 for implementing automatic sequencing of software tests using dependency information according to some aspects of the present disclosure. The system 300 includes a processor 302 communicatively coupled with a memory 304. In some examples, the processor 302 and the memory 304 can be part of the same computing system, such as the computing system 102 of FIG. 1.

The processor 302 can include one processor or multiple processors. Non-limiting examples of the processor 302 include a Field-Programmable Gate Array (FPGA), an application-specific integrated circuit (ASIC), a microprocessor, etc. The processor 302 can execute instructions 306 stored in the memory 304 to perform operations. In some examples, the instructions 306 can include processor-specific instructions generated by a compiler or an interpreter from code written in any suitable computer-programming language, such as C, C++, C#, etc.

The memory 304 can include one memory device or multiple memory devices. The memory 304 can be non-volatile and may include any type of memory device that retains stored information when powered off. Non-limiting examples of the memory 304 include electrically erasable and programmable read-only memory (EEPROM), flash memory, or any other type of non-volatile memory. At least some of the memory device includes a non-transitory computer-readable medium from which the processor 302 can read instructions 306. A non-transitory computer-readable medium can include electronic, optical, magnetic, or other storage devices capable of providing the processor 302 with the instructions 306 or other program code. Non-limiting examples of a non-transitory computer-readable medium include magnetic disk(s), memory chip(s), ROM, random-access memory (RAM), an ASIC, a configured processor, optical storage, or any other medium from which a computer processor can read the instructions 306.

In some examples, the processor 302 can receive dependency information 308 indicating dependency relationships among software tests 316 usable to test a target software item 310. The processor 302 can determine assignments of the software tests 316 to different testing phases A-N in a sequence of testing phases 314 based on the dependency information 308. The processor 302 can assign each software test among the software tests 316 to a particular testing phase in the sequence of testing phases 314 based on whether the software test is a dependency of or is a dependent on another software test among the software tests 316. In this way, the processor 302 can assign each testing phase in the sequence of testing phases 314 a unique subset of software tests 312a-n from among the software tests 316. The processor 302 can generate an output 318 indicating the assignments of the software tests 316 to the different testing phases in the sequence of testing phases 314.

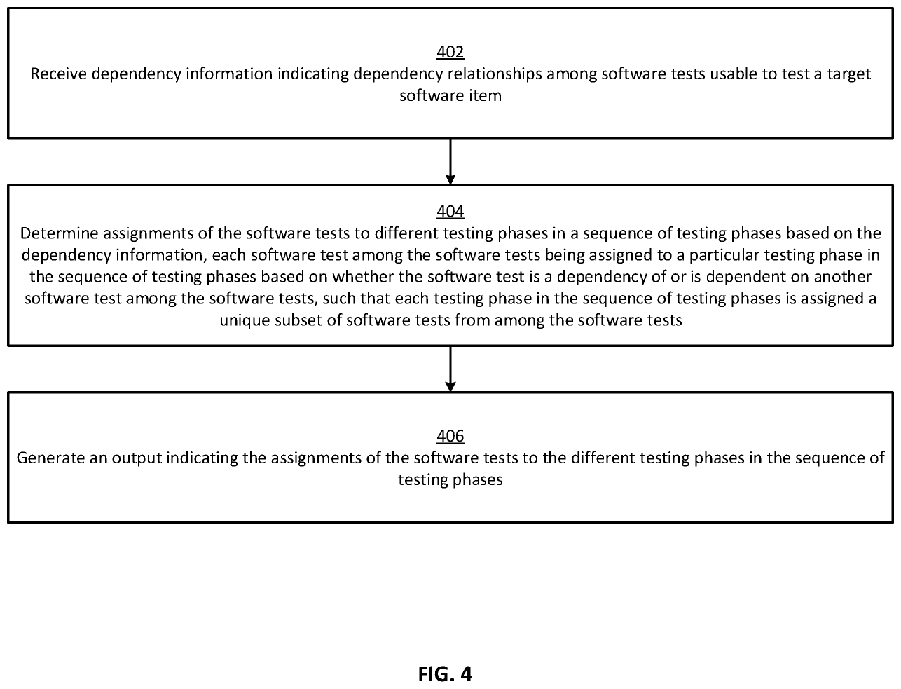

In some examples, the processor 302 can implement some or all of the steps shown in FIG. 4. Other examples can include more steps, fewer steps, different steps, or a different order of the steps than is shown in FIG. 4. The steps of FIG. 4 are discussed below with reference to the components discussed above in relation to FIG. 3.

In block 402, the processor 302 receives dependency information 308 indicating dependency relationships among software tests 316 usable to test a target software item 310. In some examples, the dependency information 308 can be predefined and stored in files associated with the software tests 316. The processor 302 can access the files to receive the dependency information 308 therefrom.

In block 404, the processor 302 determines assignments of the software tests 316 to different testing phases in a sequence of testing phases 314 based on the dependency information 308. Each software test in the software tests 316 can be assigned to a particular testing phase in the sequence of testing phases 314 based on whether the software test is a dependency of or is dependent on another software test among the software tests 316, such that each testing phase in the sequence of testing phases 314 is assigned a unique subset of software tests 312a-n from among the software tests 316.

In block 408, the processor 302 generates an output 318 indicating the assignments of the software tests 316 to the different testing phases in the sequence of testing phases 314. In some examples, generating the output 318 may involve the processor 302 storing the assignments in memory for subsequent use. Additionally or alternatively, generating the output 318 may involve the processor 302 outputting a display signal for causing a display device (e.g., an LED or LCD display) to visually indicate the assignments. Additionally or alternatively, generating the output 318 may involve the processor 302 transmitting an electronic communication to a remote device, such as a client device, indicating the assignments.

In some examples, the processor 302 can receive an input indicating that the target software item 310 is to be tested. In response to the receiving the input, the processor 302 can execute the sequence of testing phases 314 on the target software item 310 to test for errors relating to the target software item 310. For example, the processor 302 can retrieve the assignments from memory and use the retrieved assignments to execute the software tests 316 in accordance with the sequence of testing phases 314. The processor 302 can then generate another output indicating the test results from the sequence of testing phases 314.

The foregoing description of certain examples, including illustrated examples, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure. For instance, various examples described herein can be combined together to yield further examples.

1. A system comprising:
a processor; and
a memory including instructions executable by the processor for causing the processor to:
obtain dependency information indicating dependency relationships among a plurality of software tests usable to test a target software item, wherein the dependency information indicates whether each individual software test in the plurality of software tests is dependent upon another software test;
determine assignments of the software tests to different testing phases in a sequence of testing phases based on the dependency information, each software test among the software tests being assigned to a particular testing phase in the sequence of testing phases based on a corresponding subpart of the dependency information indicating a dependency level of the software test in a dependency hierarchy, such that each testing phase in the sequence of testing phases is assigned a unique subset of the software tests that correspond to a same dependency level in the dependency hierarchy; and
subsequent to determining the assignments, perform a particular testing phase in the sequence of testing phases on the target software item to test for errors relating to the target software item by:
determining that two or more software tests assigned to the particular testing phase conflict with one another; and
based on determining that the two or more software tests conflict with one another, execute the two or more software tests in sequence to one another during the particular testing phase.

2. The system of claim 1, wherein the memory further includes instructions executable by the processor for causing the processor to perform each respective testing phase in the sequence of testing phases on the target software item by:
executing the unique subset of software tests assigned to the respective testing phase on the target software item to generate a respective set of test outputs for the respective testing phase, without executing a remainder of the software tests; and
sharing the respective set of test outputs with a subsequent testing phase in the sequence of testing phases, if the respective testing phase is not a final testing phase in the sequence of testing phases.

3. The system of claim 2, wherein sharing the respective set of test outputs with the subsequent testing phase involves storing the respective set of test outputs in a data structure stored in a volatile memory device, the data structure being shared among the respective testing phase and the subsequent testing phase.

4. (canceled)

5. The system of claim 1, wherein the memory further includes instructions executable by the processor for causing the processor to perform another testing phase in the sequence of testing phases on the target software item by:
determining that two or more software tests assigned to the other testing phase do not conflict with one another; and
based on determining that the two or more software tests do not conflict with one another, executing the two or more software tests in parallel to one another during the other testing phase.

6. The system of claim 1, wherein the memory further includes instructions executable by the processor for causing the processor to:
perform the each testing phase in the sequence of testing phases on the target software item; and
subsequent to performing the sequence of testing phases on the target software item, generate an output indicating which of the software tests passed, failed, and were skipped during the sequence of testing phases.

7. The system of claim 1, wherein the memory further includes instructions executable by the processor for causing the processor to perform each respective testing phase in the sequence of testing phases by, for each respective testing phase in the sequence of testing phases:
completing the unique subset of software tests assigned to the respective testing phase prior to transitioning to a next testing phase in the sequence of testing phases.

8. The system of claim 1, wherein the software tests exclude unit tests.

9. The system of claim 1, wherein the dependency information is generated by a user and stored in files associated with the software tests.

10. A method comprising:
obtaining, by a processor, dependency information indicating dependency relationships among a plurality of software tests usable to test a target software item, wherein the dependency information indicates whether each individual software test in the plurality of software tests is dependent upon another software test;
determining, by the processor, assignments of software tests to different testing phases in a sequence of testing phases based on the dependency information, each software test among the software tests being assigned to a particular testing phase in the sequence of testing phases based on a corresponding subpart of the dependency information indicating a dependency level of the software test in a dependency hierarchy, such that each testing phase in the sequence of testing phases is assigned a unique subset of the software tests that correspond to a same dependency level in the dependency hierarchy;
subsequent to determining the assignments, performing, by the processor, a particular testing phase in the sequence of testing phases on a target software item to test for errors relating to the target software item by:
determining that two or more software tests assigned to the particular testing phase conflict with one another; and
based on determining that the two or more software tests conflict with one another, execute the two or more software tests in sequence to one another during the particular testing phase.

11. The method of claim 10, further comprising:
performing each respective testing phase in the sequence of testing phases on the target software item by:
executing the unique subset of software tests assigned to the respective testing phase on the target software item to generate a respective set of test outputs for the respective testing phase, without executing a remainder of the software tests; and
sharing the respective set of test outputs with a subsequent testing phase in the sequence of testing phases, if the respective testing phase is not a final testing phase in the sequence of testing phases.

12. The method of claim 11, wherein sharing the respective set of test outputs with the subsequent testing phase involves storing the respective set of test outputs in a data structure stored in a volatile memory device, the data structure being shared among the respective testing phase and the subsequent testing phase.

13. (canceled)

14. The method of claim 10, further comprising performing another testing phase in the sequence of testing phases by:
determining that two or more software tests assigned to the other testing phase do not conflict with one another; and
based on determining that the two or more software tests do not conflict with one another, executing the two or more software tests in parallel to one another during the other testing phase.

15. The method of claim 10, further comprising:
Performing each testing phase in the sequence of testing phases on the target software item; and
subsequent to performing the sequence of testing phases on the target software item, generating an output indicating which of the software tests passed, failed, and were skipped during the sequence of testing phases.

16. The method of claim 10, further comprising performing each respective testing phase in the sequence of testing phases by:
completing the unique subset of software tests assigned to the respective testing phase prior to transitioning to a next testing phase in the sequence of testing phases.

17. The method of claim 10, wherein the software tests exclude unit tests.

18. The method of claim 10, wherein the assignments are determined based on dependency information that is generated by a user and stored in files associated with the software tests.

19. A non-transitory computer-readable medium comprising program code, wherein the non-transitory computer-readable medium is hardware, and wherein the program code is executable by a processor for causing the processor to perform operations including:
obtaining dependency information indicating dependency relationships among a plurality of software tests usable to test a target software item, wherein the dependency information indicates whether each individual software test in the plurality of software tests is dependent upon another software test;
determining assignments of software tests to different testing phases in a sequence of testing phases based on the dependency information, each software test among the software tests being assigned to a particular testing phase in the sequence of testing phases based on a corresponding subpart of the dependency information indicating a dependency level of the software test in a dependency hierarchy, such that each testing phase in the sequence of testing phases is assigned a unique subset of the software tests that correspond to a same dependency level in the dependency hierarchy;
subsequent to receiving or determining the assignments:
determining that two or more software tests assigned to a particular testing phase in the sequence of testing phases conflict with one another; and
based on determining that the two or more software tests conflict with one another, execute the two or more software tests in sequence to one another during the particular testing phase to test for errors relating to a target software item.

20. The non-transitory computer-readable medium of claim 19, further comprising program code that is executable by the processor for causing the processor to perform operations including:
receiving an input indicating that the target software item is to be tested; and
in response to receiving the input, testing for errors relating to the target software item by performing each respective testing phase in the sequence of testing phases on the target software item, wherein performing each respective testing phase involves:
executing the unique subset of software tests assigned to the respective testing phase on the target software item to generate a respective set of test outputs for the respective testing phase, without executing a remainder of the software tests; and
sharing the respective set of test outputs with a subsequent testing phase in the sequence of testing phases, if the respective testing phase is not a final testing phase in the sequence of testing phases.

21. The non-transitory computer-readable medium of claim 19, further comprising program code that is executable by the processor to determine that the two or more software tests conflict with one another based on computing-resource consumption by the two or more software tests.

22. The system of claim 1, wherein the memory further includes instructions executable by the processor to determine that the two or more software tests conflict with one another based on computing-resource consumption by the two or more software tests.
